(19) United States
(12) Patent Application Publication
(10) Pub. No.: US 2023/0144934 A1
(43) Pub. Date: May 11, 2023

(54) Egg Sampling Device

(71) Applicant: In Ovo Holding B.V., Leiden (NL)

(72) Inventors: Wil Marijn Stutterheim, Leiden (NL); Leonard Van Bommel, Leiden (NL); Jarno Van De Wel, Enschede (NL); Michiel Leemker, Enschede (NL)

(73) Assignee: In Ovo Holding B.V., Leiden (NL)

(21) Appl. No.: 17/792,175

(22) PCT Filed: Jan. 18, 2021
(86) PCT No.: PCT/NL2021/050030

§ 371 Date: Jul. 12, 2022

(30) Foreign Application Priority Data
Jan. 17, 2020 (NL) 2024700

(51) Int. Cl. A01K 43/00; G01N 1/08; G01N 1/14; G01N 35/00

(52) U.S. Cl. CPC A01K 43/00; G01N 1/08; G01N 1/14; G01N 35/0099; G01N 2001/002

(57) ABSTRACT

The present disclosure relates to an automated system for sampling an egg that includes an egg manipulator to hold and orient one or more eggs in a defined position; an opener for opening the outer shell of the egg; an extractor for removing a sample from the allantois of the egg, and which preferably includes a system to apply increased gas pressure to the extractor up to the moment of contact with the egg; a system to clean the opener or extractor before or after removing a sample from the egg; and a sealing unit for closing the opening of the egg with a sealer.

### FIELD OF THE INVENTION

The present application provides a system for sampling an egg. It relates to a method for opening and closing of eggs and cleaning the means for opening and closing with minimal mechanical movement and user interaction.

### BACKGROUND OF THE INVENTION

Avian eggs are injected with various substances for the production of vaccines or microorganisms or cells, to generate transgenic or chimeric birds, to decrease mortality rates of hatched chickens or to increase embryo growth rates of chickens. Taking samples of eggs on an industrial scale in order to monitor the status of the egg is a fairly recent development in the field. This process is non-trivial, especially when the health and proper development of the embryo needs to be taken into account. In addition, when highly sensitive methods for analyzing samples such as high-performance liquid chromatography or mass spectrometry are used the need for cross-sample contamination needs to be minimized in order to generate accurate and reproducible results. Reducing cross-sample contamination has the additional advantage of reducing negative effects on the health and proper development of the embryo.

EP2786656A1, EP1804574B1 and EP3497441A1 disclose industrial egg sampling systems and methods, but do not take into account the risk of infection of the sampled egg nor the need to reduce cross-contamination from one sampled egg to the next.

U.S. Pat. No. 9,686,969B2 discloses an injection system for injecting a substance into a specific location within an egg containing a developing avian embryo, which comprises aseptically opening and sealing the egg with a tape, sheet or membrane. While this disclosure takes into account the health and proper development of the embryo via the use of aseptic technique it does not address the additional issues that arise when samples need to be taken aseptically from the egg.

DE102016114085A1 discloses an automated toxicity testing device for fertilized poultry eggs, which comprises a sampling unit surrounded by a preferably sterile climate chamber. In addition, it discloses a method for opening and closing the egg and testing the toxicity of injected compounds in the egg. Similar to U.S. Pat. No. 9,686,969B2, this disclosure does not address taking samples from the egg.

U.S. Pat. No. 6,286,455B1 discloses a multi-site in ovo injection/sampling apparatus and related methods to deliver multiple treatment substances to predetermined areas of eggs. The apparatus may also include a cleaning solution chamber for flushing with a decontamination fluid to maintain a preferred level of sterility in the apparatus to reduce growth of undesired contaminants and cross-contamination between samples. Preferably chlorine is used.

WO2018029096A1 discloses an egg-examining device comprising a sampling device and a feeding device wherein the eggs are lifted and positioned to the sampling device at an oblique angle, between 20 and 80°. The lifter may rotate the eggs, the sampling cannulas may be rinsed with alcohol. Preferably samples of 150 μl are taken from the allantois. Disinfection generally can be done via a UV lamp.

WO2019154493A1 describes a method for sampling (allantoic fluid of) an egg by fluid coupling an interior of the egg to a source of pressure without making a hole in the shell. Disinfecting the egg may be done around the sample passage via a laser.

Hence there remains a need for a device that is capable on an industrial scale of sampling of eggs with techniques that adhere to the requirements for accurate analysis of samples according to highly sensitive analytical methods such as mass spectrometry and for preventing infection by, and prevention of the growth of pathogens in the egg after sampling via a system that is capable of cleaning the means of sampling.

### SUMMARY OF THE INVENTION

Accordingly, in a first aspect, the present invention provides an automated system for sampling an egg, comprising:
a. an egg manipulator to hold and orient one or more eggs in a defined position;
b. an opener for opening the outer shell of the egg;
c. an extractor for removing a sample from the egg, preferably form the allantois; and
d. a system to clean the opener or extractor before or after removing a sample from the egg.

It is a further object to provide a system that foresees in opening and closing the egg, preferably under aseptic conditions.

In a further aspect, the subject system relates to cleaning the means for removing a fluid sample comprising treating the means for removing a fluid sample with a disinfectant or heating the means for removing a fluid sample to a temperature selected from a range of 70° C. to 1000° C.

In yet a further aspect, the subject system relates to a means for transferring an aliquot of the sample to an analyser comprising the following steps: applying energy to an amount of sample to eject an aliquot from the amount of sample; entraining the sample droplet in a gas or liquid stream; and transporting the sample into the analyser using the gas or liquid flow.

The present invention also relates to the process of sampling an egg comprising the steps of:
a. fixing the position of the egg or a plurality of eggs;
b. opening the outer shell of the egg;
c. removing a fluid sample from the allantois inside of the egg;
d. transferring an aliquot of the sample to an analytical system;
e. sealing the opening of the egg; and
f. cleaning the object removing the sample from the inside of the egg.

Further aspects are also disclosed in the claims of the present specification.

In a further aspect, the present invention also relates to a hatchery comprising a system according to the invention, and to a method of hatching eggs to obtain a multitude of birds with a desired characteristic.

### SHORT DESCRIPTION OF THE FIGURES

FIG. 1 shows a model for an apparatus containing several openers positioned relative to an egg.

FIG. 2 shows a model for an apparatus containing several extractors, capable of moving the extractors from and to an instrument for holding comprising a multitude of sample containers.

FIG. 3 shows a schematic overview of different steps of a system for taking one or more samples from one or more eggs.

FIG. 4 shows a schematic cross section of a hollow elongated object of an extractor.

### DETAILED DESCRIPTION OF THE INVENTION

Aseptic material is understood to mean material, preferably produced via aseptic technique, with the goal of minimizing contamination by pathogens or otherwise harmful organisms to the egg or the embryo of the egg. “Eggs” herein relate to avian eggs, preferably to poultry eggs, most preferably to domestic chicken eggs.

Aseptic technique is understood to mean a set of specific practices and procedures performed under carefully controlled conditions with the goal of minimizing contamination by pathogens or otherwise harmful organisms to the egg or the embryo residing in the egg.

Cleaning is understood to mean removing unwanted substances, such as egg material, dirt, infectious agents, and other impurities, from an object or environment. Cleaning can be achieved by a variety of different means, for example by flushing with water or a solution containing a soap or detergent, using sound waves to shake particulates loose, using steam cleaning, applying one or more disinfectants, subjecting the object or environment to a sufficiently high temperature to kill or otherwise inactivate infectious agents or by thermal cleaning; a combined process involving pyrolysis and oxidation.

Disinfectant is understood to mean a chemical or thermal agent used on objects to destroy or inhibit the growth of pathogens or otherwise harmful organisms to the egg or the embryo of the egg, in particular fungi and bacteria that are endemic to hatcheries.

In the context of the present invention, the term “glue”, “sealer” or “sealant” comprises thermoplastic or thermosetting adhesives, cements, pastes and the like that are capable of adhering to a surface while simultaneously covering an opening in the surface.

Alternatively, the term “sealant” also relates to stickers, i.e. essentially flat objects comprising a suitable adhesive or glue to adhere to an egg shell. The sticker may advantageously also comprise visual data, such as an egg identification code that may provide history and identification information of an egg in a traceability system, which may also assign an egg identification code to the egg and manages the assigned egg identification code, for separating eggs into different categories.

A “tray” is understood to mean a type of product created and designed in various colors, materials, mechanisms, shapes, sizes and styles used to hold and protect a specific number of eggs.

The present system comprises a number of parts, including an egg manipulator to hold and orient one or more eggs in a defined position. Any manipulator unit or device may be suitably employed that allows to position and orient the egg, in particular at higher speeds required for an industrial scale sampling process.

Advantageously, the egg manipulator employs a vacuum or a mechanical means to hold the position of the egg. The system according to the invention further preferably comprises a system or unit to contact the egg or its immediate surrounding area with one or more disinfectants prior to the shell of the egg being opened or pierced. Disinfectants are preferably selected from one or more of hydrogen peroxide, sodium hydroxide, potassium hydroxide, peracetic acid, iodine, ethyl alcohol, isopropyl alcohol, phenolic germicides, quaternary ammonium compounds, formaldehyde, glutaraldehyde, ortho-phthalaldehyde, hypochlorite, hypochlorous acid, chlorine dioxide, sodium dichloroisocyanurate, or chloramine-T. Preferably, the system to contact the egg or its immediate surrounding area with a disinfectant prior to the shell of the egg being opened may also comprise a device for thermal disinfection/heating the contact point of the opener with the egg to a temperature of from 70° C. to 1000° C., preferably of from 100° C. to 500° C. or of from 120° C. to 300° C. The temperature of the contact point is maintained at a range of from 30° C. to 500° C. immediately prior to opening the egg, preferably of from 45° C. or 60° C. to 300° C., from 80° C. to 200°, more preferably of from 100° C. to 150° C. or about 120° C. Immediately prior to opening the egg is of from 0 s to 5 s prior to opening the egg, preferably of from 0 s to 2 s or of from 1 s to 4 s. Preferably, the opener comprises a device for punching, piercing or opening the shell selected from the group consisting of a tubular drill, a twist drill, a grinding drill, a punch, a perforator, a suction device, a laser or a chemical milling or dissolution device. Preferably, the opener is formed as punch or a perforator, comprising a distal end comprising a cutting surface having an angle of from 45-89° relative to the trajectory of the opener immediately prior to opening the egg. It may advantageously also be formed integrally with the extractor, e.g. as blunt needle with a side opening and a sampling lumen, whereby the needle tip pierces and thus opens the egg shell, whereas the needle then proceeds to sample a fluid from the egg's interior.

The extractor is configured to extract a sample from the allantois of an egg, or a multitude of eggs, in parallel or sequentially. Alternatively, the extractor may also be configured to extract a sample of albumin or blood, if so desired.

Preferably, the extractor is configured to extract a sample by traversing the air cell of the egg. Advantageously the extractor comprises a hollow elongated object. Preferably, the extractor comprises one or more hollow elongated objects attached to or incorporated in the extractor. Advantageously the hollow elongated object comprises two or more openings. The hollow elongated object is preferably configured to hold or transfer a sample from the egg. The hollow elongated object preferably comprises one or more openings at the proximate end. The one or more openings are preferably located at a distance of from 0-15 mm from the distal end of the hollow elongated object. The extractor and hollow elongated object having one or more openings is preferably formed or selected such that, from a preferred extraction point, the hollow elongated object may traverse the air cell of the egg, and enter the allantois of the egg to a depth of from 0.5-9 mm, preferably 3 mm. The hollow elongated object is preferably of an essentially right or oblique cylinder shape, and has an inner diameter of from 0.07-4.40 mm and an outer diameter of from 0.18-5.17 mm. More preferably, the hollow elongated object has an inner diameter of from 0.1-0.5 mm and an outer diameter of from 0.2-0.75 mm. The hollow elongated object may comprise at least one cutting edge, the cutting edge formed by intersecting planar surfaces, the surfaces converging towards a distal end, the angle of convergence comprising an angle of slope of from 12-179°, preferably of from 30-100°. Preferably, the hollow elongated object comprises an inner diameter of from 0.07-4.40 mm and an outer diameter of from 0.18-5.17 mm. Preferably, the hollow elongated object comprises at least one cutting edge, the cutting edge formed by intersecting planar surfaces, the surfaces converging towards a distal end, the angle of convergence comprising an angle of slope of from 12-90. Preferably, the hollow elongated object has a multi-beveled point, comprising a cannula having a lumen, the lumen extending from a first end of the cannula and having an opening defined through the first end, the first end terminating in a point with a plurality of discrete planar bevels contiguously bounding the opening, wherein one of the plurality of discrete bevels is located furthest from the point. It preferably has a length shorter than any of the other ones of the plurality of discrete bevels. Yet further, preferably, the extractor comprises a device using vacuum, capillary force, gravity, or one or more acoustic pulses to move a sample. Preferably, the extractor comprises a system to apply increased gas pressure to the extractor up to the moment of contact of the extractor with the egg. Preferably, the extractor comprises a system to apply increased gas pressure to the extractor for a suitable time period, after the extractor is not in contact with the egg. The increased gas pressure may be suitably applied to minimize the volume of air in the extractor during sampling. Alternatively the system may also be employed to move samples, and to clean the extractor by gas flow.

Preferably, the extractor is configured to remove a volume of from 100 nl to 500 μl from the egg. Advantageously, the system to clean the extractor or opener comprises means for contacting the extractor with a fluid, such as water, a solvent and/or a disinfectant.

The disinfectant is preferably selected from one or more of hydrogen peroxide, hydroxide, peracetic acid, iodine, ethyl alcohol, isopropyl alcohol, phenolic germicides, quaternary ammonium compounds, formaldehyde, glutaraldehyde, ortho-phthalaldehyde, hypochlorite, hypochlorous acid, chlorine dioxide, sodium dichloroisocyanurate, or chloramine-T, and solutions or dispersions thereof. Most preferred are alcohols, more preferably ethanol, preferably in a solution comprising of from 50% to 100% (v/v) ethanol. Advantageously, the system to clean the extractor or opener comprises thermal disinfection/heating the extractor or opener to a temperature of from 70° C. to 1000° C. Advantageously, the system to clean the extractor or opener comprises thermal disinfection/heating the extractor or opener to a temperature of from 90° C. to 190° C. Advantageously, the system to clean the extractor or opener comprises thermal disinfection/heating the extractor or opener to a temperature of from 120° C. to 160° C. Preferably, thermal disinfection/heating the extractor or opener to a temperature occurs during a period of from 0.5 s to 5 s. This time period is sufficient for an acceptable level of disinfection, while also maintaining a sufficiently high industrial sampling speed. Preferably, the extractor is configured to remove a sample from the egg within a range of from 1 s to 60 s, preferably of from 2 s to 10 s after being cleaned and/or disinfected. This time period is necessary to maintain a sufficiently high industrial sampling speed. It was found that heating the opener to a temperature of from 90° C. to 160° C. was optimal. This temperature range was sufficient for disinfection of the opener. An optimal temperature is needed to balance any thermal damage to the egg or inside structures of the egg by too high of a temperature of the opener and insufficient disinfection by too low of a temperature of the opener, while at the same time providing a sufficiently high industrial sampling speed. Preferably, the system to clean the extractor or opener comprises treating the extractor with radiation. The radiation preferably comprises electromagnetic radiation with a wavelength of from 10-400 nm.

Preferably, the system to clean the extractor preferably is configured to flush the extractor. Advantageously, the system to clean the extractor is also configured to flush the extractor with an aqueous acid and/or an aliphatic alcohol, and preferably to dry the extractor by blowing a gaseous stream onto or along the extractor, to avoid clogging or deposition of egg shell or membrane remnants in the extractor. Preferably, the system to clean the extractor preferably is configured to descale the extractor with a descaling agent. Descaling is commonly performed to remove limescale from metal surfaces in contact with (hot) water. Descaling agents are usually acidic compounds and applied in solution and at a concentration to sufficiently remove the limescale. Examples of descaling agents are acetic acid, citric acid, glycolic acid, formic acid, lactic acid, phosphoric acid, sulfamic acid and hydrochloric acid. Inhibited or buffered acids that inhibit the corrosive effect of the acids on the extractor may also be used.

Preferably the system further comprises a sealing unit for closing the opening of the egg with a sealant, using a sealing unit. Advantageously, the sealing unit is configured to immediately close the opening of the egg after the sample extraction. Preferably, the sealant comprises an aseptic material. Preferably, the sealant comprises an adhesive material, such as a glue, a hotmelt material, a wax, or any other useful sealing material, which preferably solidifies within a time period of from 0-30 s, more preferably 0.1 to 1 s after application, preferably which seals the opening immediately. Preferably, the sealant is a food safe sealant, more preferably biologically degradable in view of the egg shells eventually being discarded. Useful sealers include hot melt sealant or similar adhesives.

Useful applicators include spray or drip applicators, e.g. heated nozzles, such as automated glue guns.

Alternatively, an adhesive sticker may be employed, which suitably may also comprise egg information data; and/or has the added benefit that the thermal exposure of the egg is lower, and the surface of the egg remains essentially flat, allowing easier handling using vacuum suction units.

Preferably, the hole in the egg shell is closed hermetically by the sealing material.

It was found that the above characteristics of the sealant or sticker are beneficial for an optimal prevention of infection of the egg, while also minimizing any damage to the egg or the inside structures of the egg by the sealer and providing a sufficiently high industrial processing speed of the egg.

The present invention also relates to a method of sampling one or more eggs, comprising the steps of: holding and/or orienting the position of the egg; automatically opening the outer shell of the egg; automatically extracting a sample from the egg; and automatically cleaning the object removing the sample from the egg. Preferably the automated process is controlled by one or more computers. These suitably run one or more computer program products comprising instructions to cause the system to execute the steps of the method set out herein above. The present invention also relates to an intransient computer-readable medium having stored thereon the computer program. The present invention also relates to the use of a system according to the invention as described herein above, for sampling an egg.

### DETAILED DESCRIPTION OF THE FIGURES

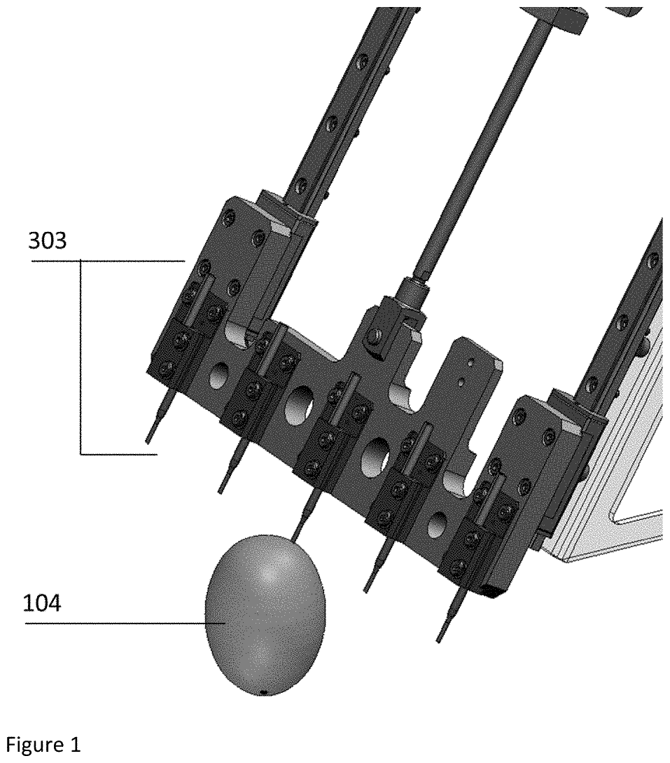

FIG. 1 shows a model for an apparatus containing several openers positioned relative to an egg. An apparatus containing five openers is located at a specific angle relative to an egg (104) being blunt side up. A single opener is indicated by (303). In this model only one egg (104) is shown, but one to five eggs can be positioned in such a way that they are all simultaneously into contact with the distal end of the five openers (303).

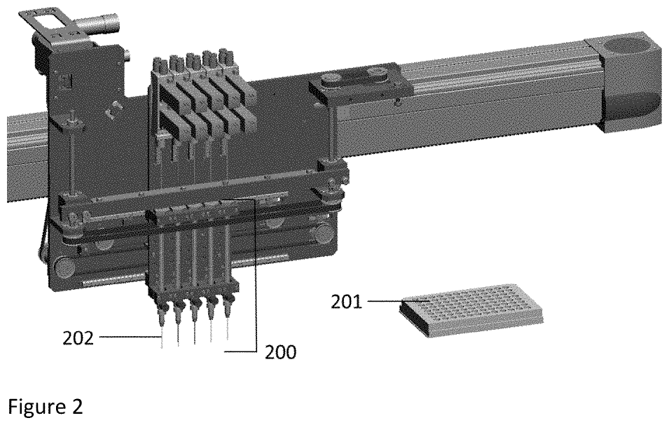

FIG. 2 shows a model for an apparatus containing several extractors, capable of moving the extractors from and to an instrument for holding comprising a multitude of sample containers. The apparatus contains one or more extractors (200) each comprising a hollow elongated object (202). This model can move the one or more extractors to and from a position above one or more eggs to and from an instrument for holding comprising a multitude of sample containers (e.g. a microtiter plate) (201).

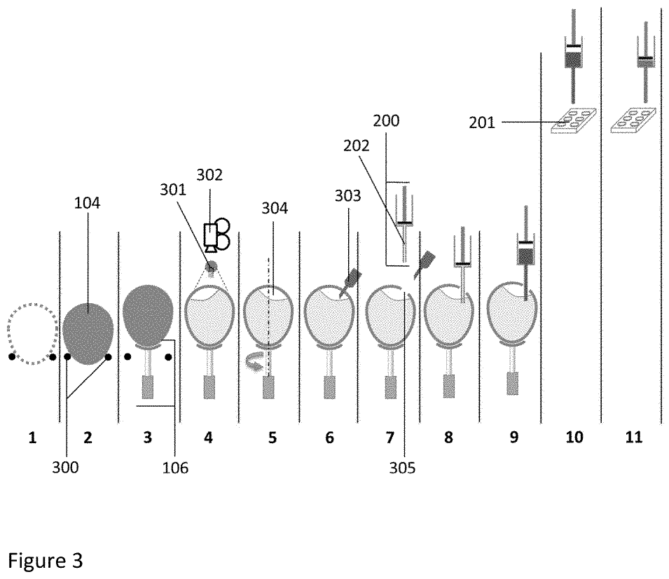

FIG. 3 shows a schematic overview of different steps of a system for taking one or more samples from one or more eggs. In step 1 an empty egg holder or tray (300) is present. In step 2 an egg (104) is placed blunt side up on the egg holder or tray (300). In step 3 an egg manipulator (106) is configured to hold the egg securely and is configured to lift the egg from the egg holder or tray (300). In step 4 the egg (104) is positioned by the egg manipulator (106) in front of a candling unit comprising a light source (301) and a detector (302) and candled. In step 5 a system which is configured to run an algorithm for determining the location of the air cell (304) of the egg (104) and a preferred extraction point (305) directs the egg manipulator (106) to rotate the egg (104) based on the information gathered by the detector (302). In step 6 the egg (104) and/or an opener (303) are positioned relative to each other in order for the opener (303) and subsequently the extractor (200) to contact the preferred extraction point (305). The opener (303) opens the egg (104). In step 7 the opener (303) is retracted from the egg (104) and the extractor (200) comprising a hollow elongated object (202) is positioned above the preferred extraction point (305). In step 8 the hollow elongated object (202) of the extractor (200) passes the preferred extraction point (305), enters the egg (104) and traverses the air cell (304). The distal end of the hollow elongated object (202) enters the allantois or a different structure of the egg (104). In step 9 the extractor (200) removes a sample from the egg (104). In step 10 the extractor is removed from the egg (104) towards an instrument for holding comprising a multitude of sample containers (e.g. a microtiter plate) (201). In step 11 the extractor (200) ejects the sample in the microtiter plate (201).

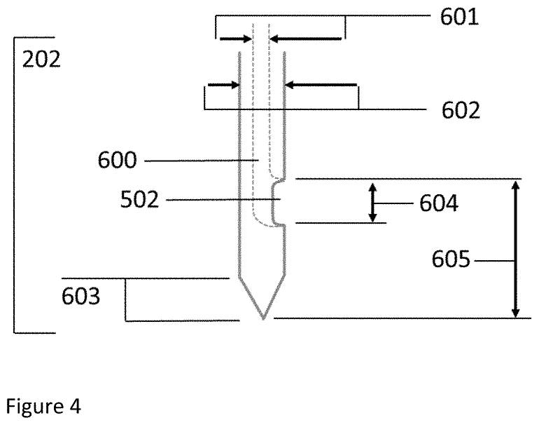

FIG. 4 shows a schematic cross section of a hollow elongated object of an extractor. The hollow elongated object (202) comprises an internal conduit (600) to hold a sample from an egg. The sample enters the hollow elongated object (202) through a lateral opening (502) which is the distal end of the internal conduit (600). The diameter of the internal conduit (600) is determined by the internal diameter (601) while the diameter of the hollow elongated object is determined by the outer diameter (602). The internal diameter (601) and the outer diameter (602) together can for example be determined by specific industry standard needle gauges. The shape of the lateral opening (502) can vary but generally consists of an opening area (604) of a specific size. The distal end of the hollow elongated object (202) can be any shape or size of tip (603), in this figure illustrated by a cutting edge, the cutting edge formed by intersecting planar surfaces, the surfaces converging towards a distal end, the angle of convergence comprising an angle of slope of 55°. The distance from the distal end of the hollow elongated object (202) to the most proximal end of the lateral opening (502) is termed the tip to port distance (605), and can vary.

The present invention has been described above with reference to a number of exemplary embodiments as shown in the drawings. Modifications and alternative implementations of some parts or elements are possible and are included in the scope of protection as defined in the appended claims.

1. An automated system for sampling an egg, comprising:
an egg manipulator to hold and orient one or more eggs in a defined position;
an opener for opening an outer shell of the egg;
an extractor for removing a sample from allantois of the egg;
a system to clean the opener or the extractor before or after removing the sample from the egg, and
a sealing unit for closing the opening of the outer shell with a sealant.

2. The automated system according to claim 1, wherein the egg manipulator comprises a vacuum or a mechanical means to hold the one or more eggs in the defined position.

3. The automated system according to claim 1, further comprising a system to contact the egg, entirely, or at the extraction point and/or its immediate surrounding area, with one or more disinfectants prior to the outer shell of the egg being opened, preferably prior to entering the manipulator; and wherein the disinfectant is selected from one or more of the group consisting of hydrogen peroxide, sodium hydroxide, potassium hydroxide, peracetic acid, iodine, ethyl alcohol, isopropyl alcohol, phenolic germicides, quaternary ammonium compounds, formaldehyde, glutaraldehyde, ortho-phthalaldehyde, hypochlorite, hypochlorous acid, chlorine dioxide, sodium dichloroisocyanurate, or chloramine-T, or solutions or dispersions thereof.

4. The automated system according to claim 1, wherein the system comprises an assembly comprising a multitude of egg manipulators, an assembly comprising a multitude of openers, an assembly comprising a multitude of egg manipulators extractors, an assembly comprising a multitude of cleaning means, and an assembly comprising a multitude of sealers.

5. The automated system according to claim 3, wherein the system to contact the egg or its immediate surrounding area with a disinfectant prior to the outer shell of the egg being opened comprises thermal disinfection/heating the contact point of the opener with the egg to a temperature of from 70° C. to 1000° C.

6. The automated system according to claim 1, wherein the opener comprises a device for punching, piercing or opening the shell selected from the group consisting of a tubular drill, a twist drill, a grinding drill, a punch, a perforator, a suction device, a laser or the process of chemical milling.

7. The automated system according to claim 1, wherein the opener comprises a distal end comprising a surface at an angle of from 45-89° relative to the trajectory of the opener immediately prior to opening the egg.

8. The automated system according to claim 1, wherein the extractor comprises a hollow elongated object, preferably attached to, or integrated with the extractor.

9. The automated system according to claim 8, wherein the hollow elongated object comprises two or more openings.

10. (canceled)

11. The automated system according to claim 7, wherein the hollow elongated object comprises an inner diameter of from 0.07-4.40 mm and an outer diameter of from 0.18-5.17 mm.

12. The automated system according to claim 7, wherein the hollow elongated object comprises at least one cutting edge, the cutting edge formed by intersecting planar surfaces, the surfaces converging towards a distal end, the angle of convergence comprising an angle of slope of from 12-90°.

13. The automated system according to claim 7, wherein the hollow elongated object has a multi-bevelled point, comprising a cannula having a lumen extending from a first end of the cannula and having an opening defined through the first end, the first end terminating in a point with a plurality of discrete planar bevels contiguously bounding the opening, wherein one of the plurality of discrete bevels is located furthest from the point.

14. The automated system according to claim 1, wherein the extractor comprises a device using vacuum, capillary force, gravity, or one or more acoustic pulses.

15. The automated system according to claim 1, wherein the extractor is configured to remove a sample volume of from 100 nL to 500 μL from the egg.

16. The automated system according to claim 1, wherein the system to clean the extractor or the opener comprises contacting the extractor with an aqueous liquid, an acid; a solvent; or a disinfectant, preferably selected from one or more of hydrogen peroxide, hydroxide, peracetic acid, iodine, ethyl alcohol, isopropyl alcohol, phenolic germicides, quaternary ammonium compounds, formaldehyde, glutaraldehyde, ortho-phthalaldehyde, hypochlorite, hypochlorous acid, chlorine dioxide, sodium dichloroisocyanurate, or chloramine-T.

17. The automated system according to claim 1, wherein the system to clean the extractor or the opener comprises thermal disinfection/heating the extractor or the opener to a temperature of from 70° C. to 1000° C.

18. The automated system according to claim 16, wherein the system to clean the extractor or the opener comprises a thermal disinfection/heating unit for heating the extractor or opener to a temperature of from 90° C. to 190° C., preferably, by subjecting it to radiation, such as electromagnetic radiation with a wavelength of from 10-400 nm, or a heating unit to maintain the extractor or opener at a temperature of from 90° C. to 190° C.

19. (canceled)

20. (canceled)

21. The automated system according to claim 1, wherein the extractor is configured to extract a sample from the allantois of one or more eggs by traversing an air cell of the egg.

22. A method of sampling one or more eggs, comprising the steps of:
holding and/or orienting a position of the one or more eggs;
automatically opening an outer shell of the one or more eggs;
automatically extracting a sample from the allantois of the one or more eggs;
automatically cleaning the extractor removing the sample from the egg, and
sealing the opening in the outer shell after sampling.

23. The method according to claim 22, further comprising the steps of:
disinfecting at least one of the one or more eggs, the opener, the extractor; and
transferring the sample to an assaying or detection device.

24-26. (canceled)
